(19) United States
(12) Patent Application Publication
(10) Pub. No.: US 2013/0220313 A1
(43) Pub. Date: Aug. 29, 2013

(54) PORTABLE COLLAPSIBLE STOVE

(71) Applicant: Ellis Design Associates Limited, (US)

(72) Inventor: Peter Ellis, Wimborne (GB)

(73) Assignee: Ellis Design Associates Limited, Wimborne (GB)

(21) Appl. No.: 13/736,774

(22) Filed: Jan. 8, 2013

Related U.S. Application Data
(63) Continuation-in-part of application No. 12/093,701, filed on Sep. 22, 2008.

(30) Foreign Application Priority Data
Nov. 15, 2005 (GB) 0523234.3
Jan. 9, 2012 (GB) 1200251.5

(51) Int. Cl. A47J 33/00

(52) U.S. Cl. CPC A47J 33/00
USPC 126/9 B

(57) ABSTRACT

A foldable burner has a raised platform formed from aluminum foil portions and onto which fuel can be placed. Tabs are provided for gripping by a user to expand the burner from a collapsed condition to an expanded condition. Tabs may also act as supports to strengthen the burner and make the burner more stable. Apertures enable air to enter the burner under a chimney effect in order to provide oxygen to fuel for burning. The upper periphery of the burner provides support for a cooking vessel such as a saucepan. The burner is easy to transport in its folded condition. Further, it may be designed to offer a second use as transportation box.

### FIELD OF THE INVENTION

The present invention relates to a portable collapsible stove.

### BACKGROUND TO THE INVENTION

Portable collapsible stoves are well known and many different types have been proposed. Such stoves can be easily carried in a backpack or the like, and may be known as ‘single’ stoves in that they are arranged to heat food or liquid in a single container. Some of the prior art stoves comprise some sort of collapsible metal frame arranged to provide a fuel locating region, and supports to support a container above the fuel. It has been previously proposed to provide a portable collapsible stove formed from rigid metal sheets hinged together to form an outer windshield and an inner fuel support platform. Such prior proposals are typically relatively heavy, noisy and dirty to use, and provide inefficient, uncontrolled combustion.

We have provided an early solution to the above problems with the portable collapsible solid fuel stove described in our European patent application EP 1957870 of 18 Jul. 2006.

### SUMMARY OF THE INVENTION

The present invention stems from significant developments of our above stove, and from work in providing an improved solution to the above problems.

According to a first aspect of the invention there is provided a portable collapsible stove, the stove being formed from sheet laminate material, the laminate material comprising at least one planar sheet of a metal material adhered to, at least one planar non-metallic substrate, the stove comprising a plurality of side walls formed from the sheet laminate material, each side wall comprising a pair of side margins, the side margins of adjacent side walls being fastened together such that the side walls together define a tube one end of which comprises a base which rests in use on the ground and an opposed end of which comprises a mouth to at least partially receive, and support, in use a container or the like, the stove further comprising a fuel support platform also formed from the sheet laminate material, the fuel support platform being located inside the tube at a position spaced from the base of the tube, with the outer periphery of the fuel support platform being fastened to the side walls, at least one air inlet aperture being provided in a side wall below the fuel support platform, at least one exhaust aperture being provided in a side wall above the fuel support platform, the combination of the structure of the sheet of laminate material, the fastening of the side margins of adjacent side walls and the fastening of the outer periphery of the fuel support platform being such that the stove can be collapsed from an operational condition in which the side walls define the tube and the fuel support platform extends across the tube, to a collapsed, substantially flat condition in which the side walls and fuel support platform are substantially parallel. The stove may further comprise at least one aperture shield arranged to extend across each inlet and exhaust aperture to block light emitted through each aperture in use. The at least one aperture shield may comprise a vent spaced from the aperture and operative to allow gas flow through the aperture. Preferably all of the apertures are covered by at least one of the shields. Each of the shields may cover only one, or more than one, of the apertures.

Preferably each aperture shield comprises an oblong flap fixed to the respective wall of the stove below the inlet or exhaust aperture in question, the upper part of the flap not being fastened to the respective wall, and so defining a vent in communication with the inlet or exhaust aperture in question.

Preferably the or each flap is movably mounted on the respective wall so as to be movable from an operational condition in which the upper end of the flap is distal from the respective wall, to a partially collapsed condition in which the upper end of the flap is adjacent the respective wall.

Preferably the side margins of the flap are fastened to the respective wall by way of pleated sides which allow the flap to be moveable between the operational and collapsed conditions.

Preferably the sheet laminate material further comprises an anti-reflecting coating. The coating may be provided on a surface of the material which forms an outer surface of the stove in use. The surface may be formed by the metal foil, or may be formed by the non-metallic substrate. The anti-reflecting coating may comprise matt black paint, or it may comprise graphite, or it may comprise PTFE.

Preferably the walls are fastened together using stitching incorporating a fire retardant thread. The fire retardant thread may comprise a glass fibre thread. The fire retardant thread may be impregnated and/or coated with PTFE and/or Graphite. The Graphite renders the thread black and therefore of low visibility.

Preferably the fuel support platform is fastened to the tube using a fire survivable fastener.

Preferably the fire survivable fastener comprises stitching incorporating a fire retardant thread.

The fire survivable fastener may comprise a metallic or non-metallic material. The fire survivable fastener may comprise a staple or rivet for example, or may comprise adhesive. Combinations of any of stitching, rivets, staples and adhesive are envisaged as may be required to meet structural, manufacturing or cost based objectives.

Preferably a pull tab is provided on the underside of the fuel support platform, a user pulling the pull tab to assist with moving the stove from the collapsed condition to the operational condition.

Preferably the side margins of each wall are bent outwardly from the plane of the wall to define a side wall fin, adjacent side wall fins being fastened together.

The non-metallic substrate of the sheet of laminate material may comprise a glass fibre mat. The non metallic substrate may be impregnated and/or coated with PTFE.

According to a second aspect of the invention there is provided a portable collapsible stove, the stove being formed from sheet laminate material comprising two opposed planar sheets of a metal foil material which together sandwich, and are adhered to, a planar non-metallic substrate, the stove comprising a plurality of oblong walls formed from the sheet laminate material, each wall comprising a pair of side margins, the side margins of adjacent walls being joined together such that the walls together define a tube one end of which comprises a base which rests in use on the ground and an opposed end of which comprises a mouth to at least partially receive, and support, in use a container or the like, the stove further comprising a fuel support platform also formed from the sheet laminate material, the fuel support platform being located inside the tube at a position spaced from the base of the tube, with at least a part of the outer periphery of the fuel support platform being joined to the side walls inside the tube, at least one air inlet aperture being provided in a side wall below the fuel support platform, at least one exhaust aperture being provided in a side wall above the fuel support platform, the structure of the sheet of laminate material, the fastening of the side margins of adjacent side walls and the fastening of the outer periphery of the fuel support platform being arranged such that the stove can be collapsed from an operational condition in which the sidewalls define the tube and fuel support platform, to a collapsed, substantially flat condition in which the walls and fuel support platform are substantially parallel.

According to a third aspect of the invention there is provided a portable collapsible solid fuel stove, the stove being formed from sheet laminate material comprising two opposed planar sheets of a metal foil material which together sandwich, and are adhered to, a planar non-metallic substrate, the stove comprising a plurality of oblong walls formed from the sheet laminate material, each wall comprising a pair of side margins, the side margins of adjacent walls being stitched together such that the walls together define a tube one end of which comprises a base which rests in use on the ground and an opposed end of which comprises a mouth to at least partially receive, and support, in use a container or the like, the stove further comprising a fuel support platform also formed from the sheet laminate material, the fuel support platform being located inside the tube at a position spaced from the base of the tube, with the outer periphery of the fuel support platform being stitched to the side walls inside the tube, at least one air inlet aperture being provided in a side wall below the fuel support platform, at least one exhaust aperture being provided in a side wall above the fuel support platform, the structure of the sheet of laminate material, the fastening of the side margins of adjacent side walls and the fastening of the outer periphery of the fuel support platform being arranged such that the stove can be collapsed from an operational condition in which the sidewalls define the tube and fuel support platform, to a collapsed, substantially flat condition in which the walls and fuel support platform are substantially parallel.

The laminate material may be flexible. The fuel support platform may have two opposite sides each of which is attached to one of the side walls. The fuel support platform may be foldable to allow the stove to be collapsed from the operation condition to the collapsed condition.

According to a fourth aspect of the invention there is provided a sheet of laminate material comprising at least one planar sheets of a metal foil material adhered, using fire retardant adhesive, to at least one planar non-metallic substrate, the resulting laminate sheet being fireproof such that the structural integrity of the resulting laminate sheet is stable when subject to flame temperatures of up to 1000° C., the resulting laminate sheet also being flame retardant such that the integrity of the resulting laminate sheet is stable when subject to repeated exposure to flames.

Other aspects of the present invention may include any combination of the features or limitations referred to herein.

The present invention may be carried into practice in various ways, but embodiments will now be described by way of example only with reference to the accompanying drawings.

### BRIEF DESCRIPTION OF THE DRAWINGS

FIGS. 1a and 1b are perspective views of two examples of a sheet of laminate material used to form a portable collapsible stove in accordance with the present invention;

FIG. 2 is a perspective view from the top, front and one side of a portable collapsible stove in accordance with the present invention;

FIG. 3 is a plan view of the stove of FIG. 2;

FIG. 4 is a perspective view of the stove of FIGS. 2 and 3 in a collapsed condition;

FIG. 5 is a perspective sectional view of the stove of FIGS. 2 to 4, taken on line A-A of FIG. 2, illustrating the inlet and exhaust gas flow paths;

FIG. 6 is a perspective view from the top, front and one side of another portable collapsible stove in accordance with the present invention;

FIG. 7 is a plan view of the stove of FIG. 6;

FIG. 8 is a perspective view of the stove of FIGS. 6 and 7 in a partially collapsed condition;

FIG. 9 is a plan view corresponding to FIG. 8;

FIG. 10 is a perspective view from one side of the stove of FIGS. 6 to 9 in a fully collapsed condition;

FIG. 11 is a perspective from the other side of the stove of FIGS. 6 to 10 in a fully collapsed condition;

FIG. 12 is a perspective sectional view of the stove of FIGS. 6 to 11 taken on line B-B of FIG. 6, illustrating the inlet and exhaust gas flow paths;

FIG. 13 is a perspective sectional view of the stove of FIGS. 6 to 12 taken on line C-C of FIG. 6, illustrating the inlet and exhaust gas flow paths;

FIG. 14 is a perspective sectional view of a modified stove in accordance with the present invention;

FIG. 15 is a perspective sectional view of the modified stove of FIG. 14 in use with a gas burner;

FIG. 16 is a perspective sectional view of the modified stove of FIG. 14 in use with a liquid fuel burner; and

FIG. 17 is a perspective sectional view of the modified stove of FIG. 14 in use with a gel fuel container.

### DESCRIPTION OF THE PREFERRED EMBODIMENTS

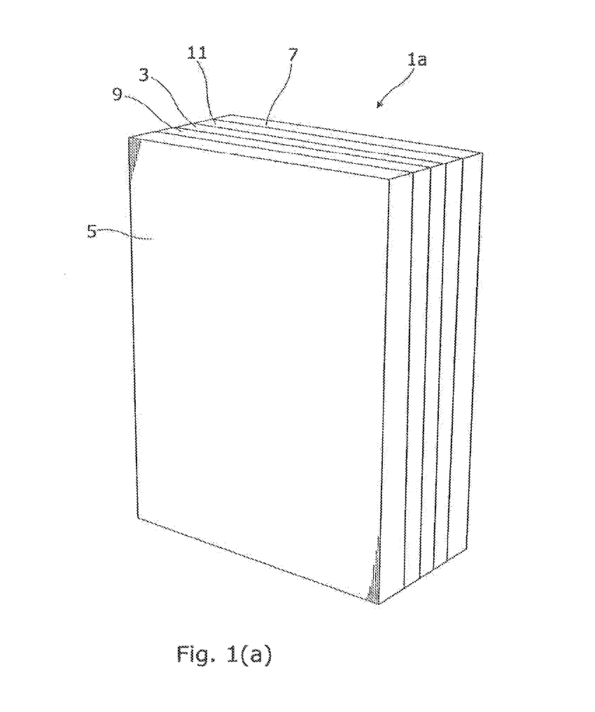

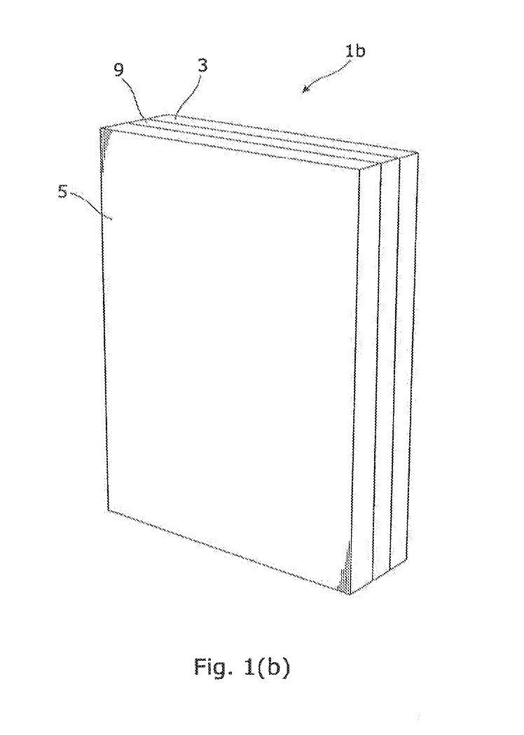

Referring initially to FIG. 1a a first example sheet of laminate material 1a comprises a non-metallic substrate 3 sandwiched between two sheets of metal foil material, which in this case is aluminium foil material 5, 7, though other metals could be used. The aluminium foil sheets 5, 7 are glued to the substrate 3 by respective adhesive layers 9, 11.

In a preferred example, the non-metallic substrate 3 comprises a plastic covered glass fibre mat. The substrate 3 may be impregnated and/or coated with PTFE.

The adhesive layers 9, 11 are formed from a single or a composite material including a fire retardant adhesive.

The laminate sheet 1 is thus five-ply in this example.

Referring to Figure 1b, another example laminate sheet 1b has similar features to the sheet 1a described but is three-ply in this example. The sheet 1b comprises a substrate 3 to which a single aluminium foil sheet 5 is glued by adhesive layer 9.

It will be appreciated that the laminate sheet can comprise any number of plies as required to provide the desired flame retardant and structural properties.

In a preferred embodiment, the total thickness of the laminate sheet 1a, 1b is in the range 10 to 500 μm. The thickness of the substrate 3 is in the range 5 to 200 μm. The thickness of the or each aluminium foil sheet 5, 7 is in the range 5 to 200 μm.

The resulting laminate sheet 1a, 1b displays flame retardant properties and will withstand persistent flame temperatures of up to 1000° C. for, for example, 20 to 40 minutes, and still maintain its structural integrity. In the example portable stove described below the exhaust gas temperatures are approximately in the range 200° C. to 400° C.

The resulting laminate sheet 1a, 1b exhibits sufficient rigidity that a container of liquid can be supported by the sheet 1a, 1b without the sheet 1a, 1b deforming, bending or collapsing, when in the form of the expanded stove described below, but is sufficiently flexible that the sheet 1a, 1b can be bent or folded without distorting or deforming as a sheet of aluminium foil would normally do. The sheet 1a, 1b retains these properties under very high operating temperatures as described above.

The introduction of a non-metallic substrate of plastic coated mat 3, and adhesive layers 9, 11, allows the resulting laminate sheet 1 a, 1b to be both structural and articulate in a manner not possible with a metal foil. Thin metal foils normally permanently deform and fatigue when bending occurs, taking the material beyond its ultimate tensile strength by simple deformation pressures and movements. These changes are typically irreversible. The use of the substrate 3 allows the conformal shape of the sheet 1a, 1b to be maintained, and the properties of the metal in a high temperature environment to be exploited.

The laminate material 1a, 1b is therefore flexible, beyond the natural capability of the metal foil on its own. We have used the flexible nature of the resulting laminate material 1a, 1b as part of the advantageous stoves described below.

The laminate material 1a, 1b is capable of significant cycling without fatigue failure. Additionally, because of the cycling through the high temperatures endured during use, we have determined that the heat cycling adds a stress relieving aspect to the sheet 1a, 1b, preventing work hardening by normalising the aluminium material each time the stove is used. The sheet 1a, 1b therefore remains more flexible than would be expected from a cold worked metal material when repeatedly folded.

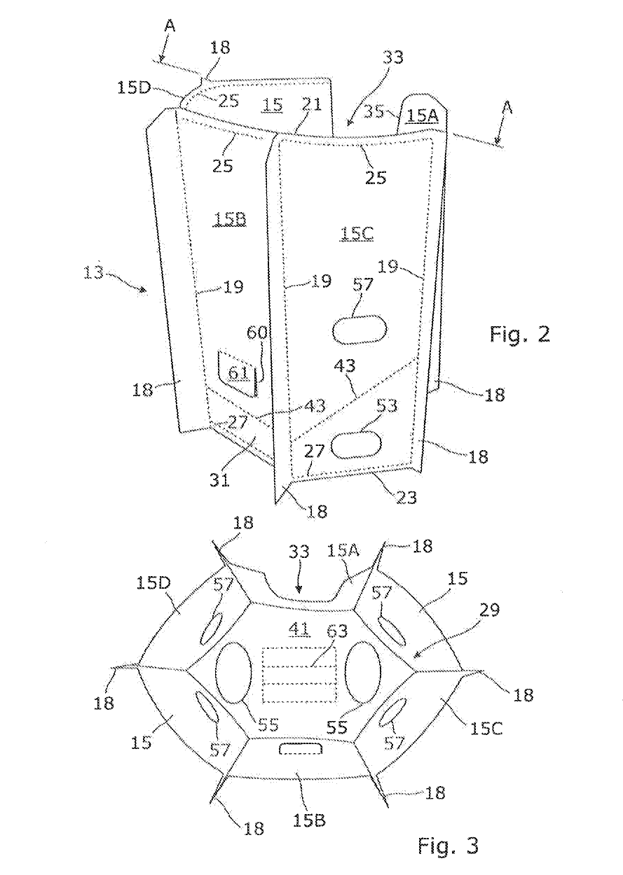

Referring additionally to FIGS. 2 and 3, a portable collapsible stove 13 has its primary components and structure formed/defined entirely from laminate sheet, such as, for example, the laminate sheets la or 1b described above.

The stove 13, in this example, comprises six planar oblong side walls 15 of the laminate sheet. The side margins of each side walls 15 are bent beyond 90° relative to the plane of each side wall 15, and each side margin is fastened to the adjacent side margin of the adjacent side wall 15 to form radially outwardly projecting fins 18. The side margins are fastened together using fire retardant stitching 19. Stitching 19 uses, in this example, a high temperature resistant PTFE coated thread formed from glass fibre. The thread may also be impregnated or coated with Graphite to render the thread low visibility.

The top and base margins 21, 23 of each side wall 15 are also stitched 25, 27 respectively to resist delamination of the laminate sheet in use.

When so fastened, the side walls 15 together define an upstanding fire resistant, high temperature resistant tube 29 one end of which functions as a base 31 which rests in use on the ground, and the opposite end of which defines a mouth 33 into which a container (not shown) is placed in use of the stove 1. One of the side walls 15A is provided with an oblong cut-out 35 to receive a handle of the container. Because the side walls 15 are formed from the laminate sheet, the side walls 15 can to some extent flex around, and conform to, the shape of the container such that the side walls 15 snugly engage the container to resist air flow between the side walls 15 and the container. The structure of the laminate sheet, and the resulting tube structure, provides sufficient strength and rigidity in compression, and resistance to bending and folding, to support the container when filled with liquid.

The stove 13 further comprises a fuel support platform 41 formed from the laminate sheet and being of generally hexagonal shape when viewed in plan, to match the generally hexagonal cross section of the tube 29, as defined by the six side walls 15. The periphery of the fuel support platform 41 is fastened to the side walls 15 inside the tube 29 by fire retardant stitching 43 as described above. The fuel support platform 41 is inclined inside the tube 29 such that the part of the platform 41 beneath the cut-out 35 is higher up the tube 29 than the opposed part of the platform 41 fastened to side wall 15B.

The fuel support platform 41 is spaced from the base 31 of the tube 29 and in this example is located about a quarter of the way up the tube 29. An air inlet manifold 51 is therefore defined between the ground on which the tube 29 rests in use, and the underside of the fuel support platform 41. The air inlet manifold 51 is provided with two external air inlet apertures 53 formed in opposed side walls 15C, 15D. The fuel support platform is itself provided with two internal air inlet apertures 55. The air inlet apertures 53, 55 form a controlled air inlet path to the region above the fuel support platform 41, that is, the region in which the fuel is placed in use.

The stove 13 is further provided with four exhaust gas outlet apertures 57, located above the fuel support platform 41. When the container is sealingly located in the mouth 33 of the tube 29, a fixed volume combustion chamber is defined between the underside of the container and the top of the fuel support platform 41 from which exhaust gas can only exit via the exhaust gas outlet apertures 57.

An access aperture 60 with closing tab 61 is provided on side wall 15b and this is used to allow a suitable ignition source, such as a match or lighter, access to the combustion chamber 59.

A tab 63 is provided on the underside of the fuel support platform 41 and this can be pulled to help expand the stove 13 from the collapsed condition described below.

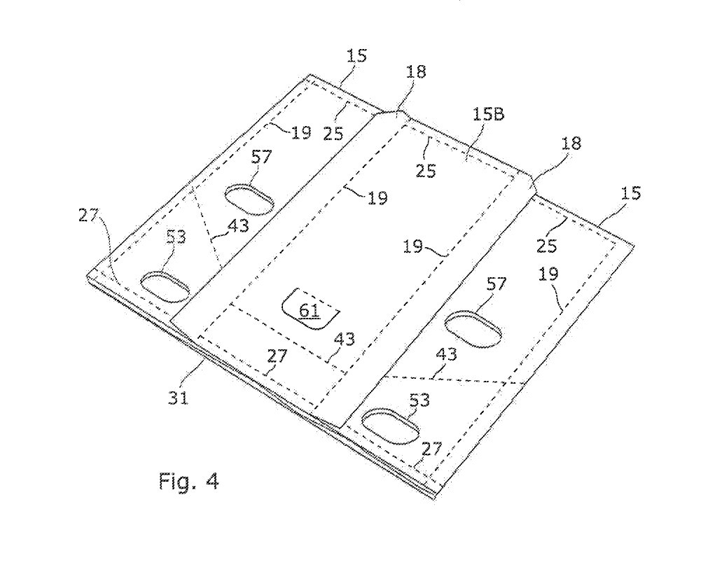

With particular reference to FIG. 4, the stove 13 can be stored/carried in a collapsed condition wherein the side walls 15 and fuel support platform 41 are folded together so as to be substantially parallel, the collapsed stove 13 thus being substantially flat.

To expand the stove 13, opposed side walls 15, or opposed fins 18 can be gripped and pulled apart to expand the stove 1 from the collapsed, substantially flat, condition, to the expanded, substantially tubular condition. The tab 63 on the underside of the fuel support platform 41 may also be pulled downwardly to pull the fuel support platform 41 from a folded condition, to a planar condition. When in the expanded condition, the stove 13 is self supporting with the base 31 of the tube 29 resting on the ground, and the fuel support platform 41 acting as a brace across the tube 29 to resist bending or folding of sidewalls 15.

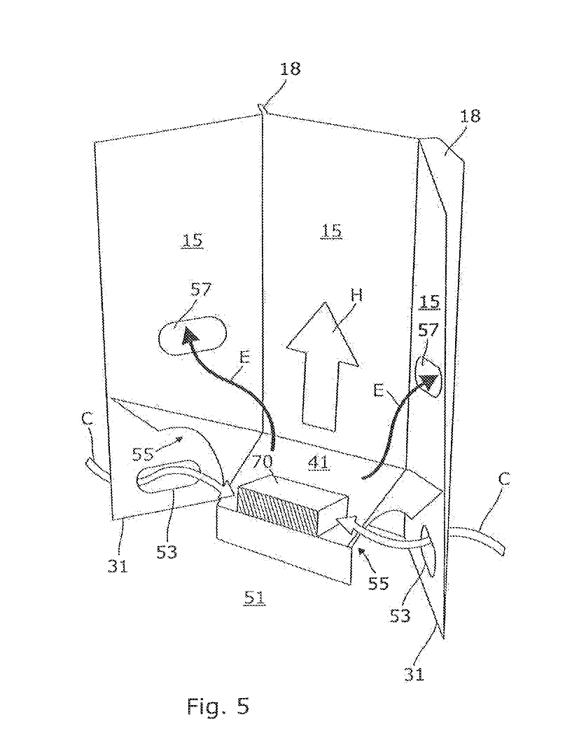

When in the expanded condition, and with reference also to FIG. 5, fuel, such as a piece of solid fuel 70, is supplied to the fuel support platform 41 and ignited using a suitable ignition source. In this example, solid fuel 70 is simply placed on the due support platform 41. Combustion air, as referenced by arrows C, is drawn into the combustion chamber 59 via the air inlet apertures 53, 55 and the air inlet manifold 51. The size, number and location of the air inlet apertures 53, 55, and the volume of the air inlet manifold 51, may be calculated to provide the volumetric air flow required for the desired fuel.

Once the fuel is ignited, or before the fuel is ignited, the container is placed into the mouth 33 of the tube 39 and this defines the fixed volume combustion chamber 59.

Exhaust from the combustion process, as indicated by arrow E, exits the combustion chamber 59 in a controlled manner via exhaust outlet apertures 57. Again, the volume of the combustion chamber 59, and the size, shape, location and number of exhaust outlet apertures 57 may be calculated to provide the required burn characteristics. Heat rises onto the container as per arrow H.

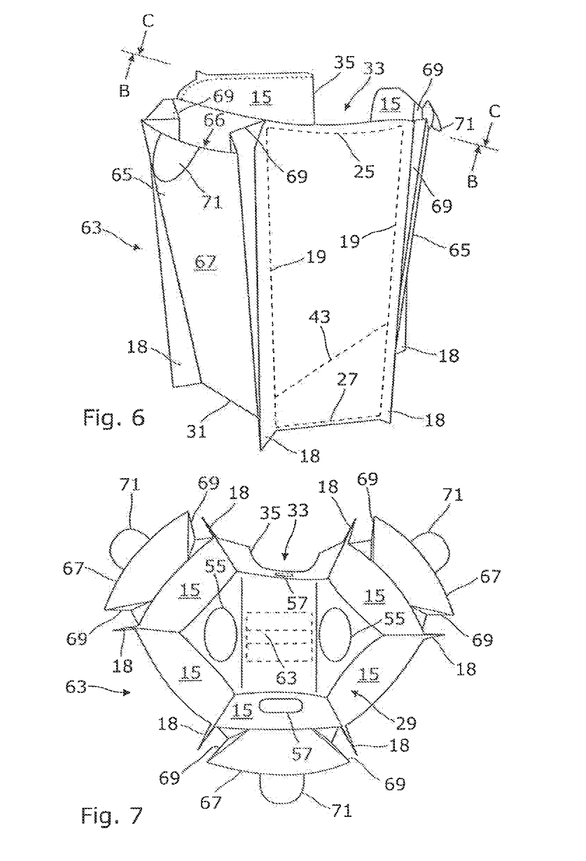

Referring additionally to FIGS. 6 to 9, a modified stove 63 comprises similar features to the stove 13 described above, like features being given like references.

Modified stove 63 further comprises low visibility features which render the stove 63 more difficult to see both during transit, and in use. Being of low visibility is a useful feature particular in military applications where the user of the stove may not wish to give away their position. Ordinarily the flames and glow from the burning fuel may be visible through the exhaust apertures 57. Furthermore, the aluminium foil of the sheets 1 of laminate material 1 would reflect any ambient or directed light.

Thus, the sheet of laminate material 1 of stove 63 comprises an additional anti-reflective coating on the external surfaces of the aluminium foil sheets 5, 7. The anti-reflective coating may comprise a matt black coating for example. The modified laminate sheet is thus seven-ply in this example.

Additionally, the stove 63 comprise aperture shields 65 each of which extends from the base 31 of the tube 29 towards the mouth 33 of the tube 29. Each aperture shield 65 comprises a flow channel 66 defined by an outer, oblong flap 67 having pleated sides 69 which extend between the side margins of the flap 67 and a respective side wall 15 of the stove 63. The bottom of each flap 67 is fastened adjacent the base 31 of tube 29. The top of each flap 67 is not fastened to the side walls 15 and is provided with a pull tab 71 to enable the top of each flap 67 to be pulled away from the respective side wall 15. When so pulled, with reference to FIGS. 6 and 7, each aperture shield 65 defines a respective flow channel 66 to allow inlet air into the exterior air inlet apertures 53, and to allow exhaust gas from the exhaust gas outlet apertures 57. The flap 67 and pleated sides 69 shield the light from the combustion process from being seen as the flap 67 and pleated sides 69 cover the respective inlet or exhaust aperture 53, 57.

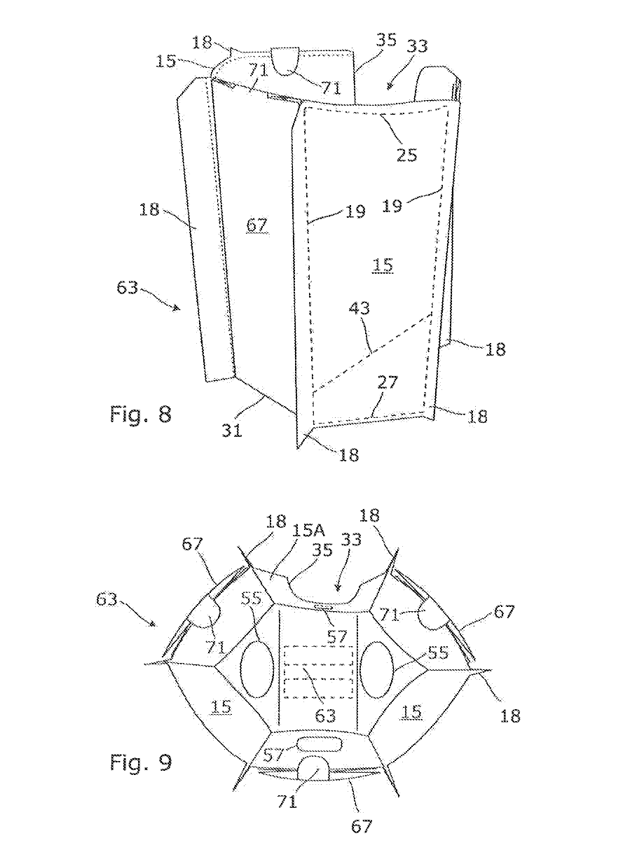

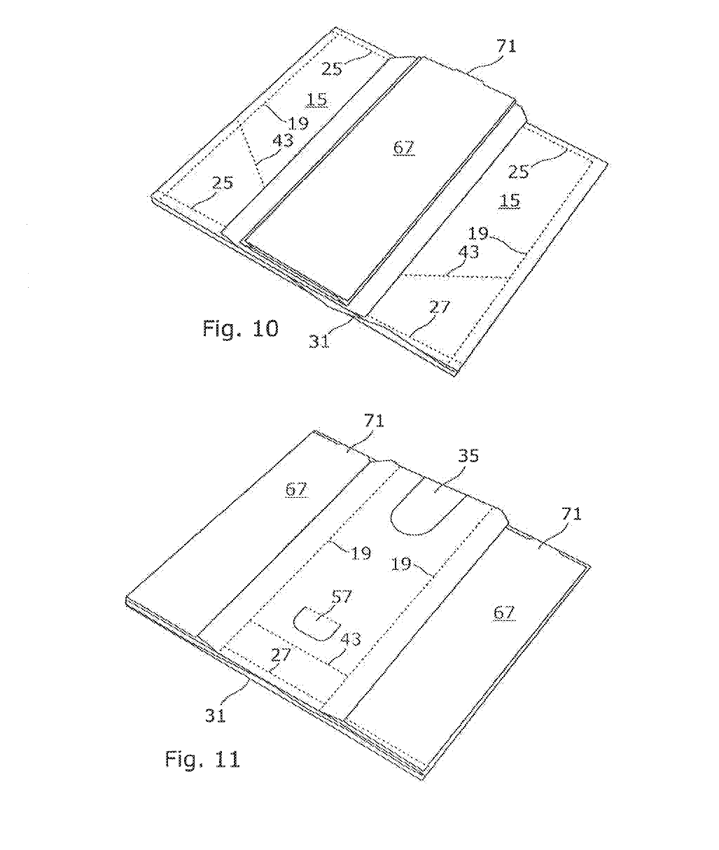

With particular reference to FIGS. 8 to 11, the stove 63 may be collapsed by first pushing the flap 67 of each aperture shield 65 towards the respective side wall 15. This collapses each flow channel 66. Opposed side walls 15 can then be pushed together, and the fuel support platform 41 folded, such that the side walls 15 and platform 41 are substantially parallel with the stove 63 in a substantially flat condition and the tube 29 is collapsed.

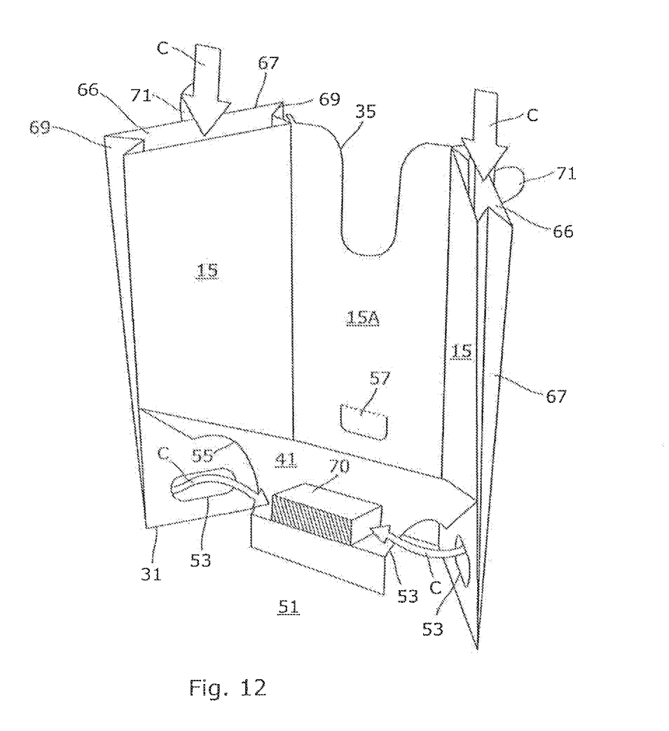

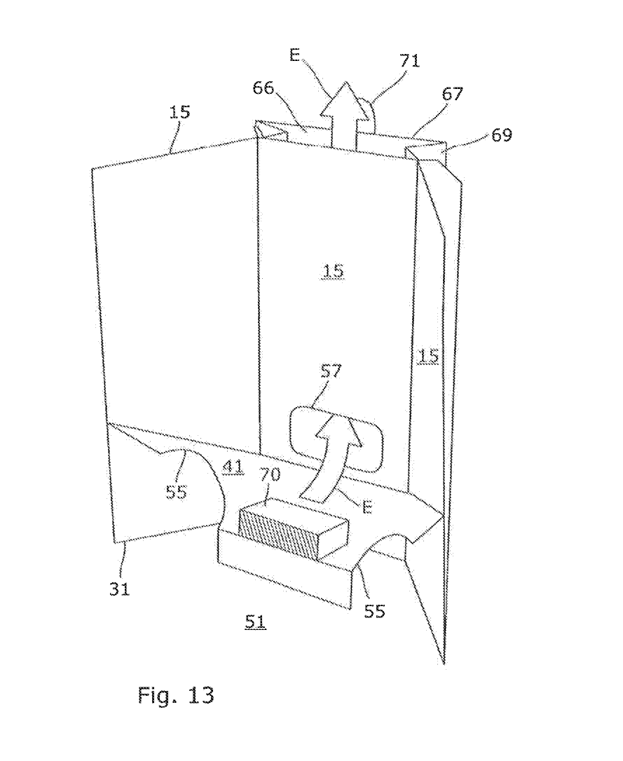

With reference to FIGS. 12 and 13, the inlet combustion air and exhaust air flow paths C, E are as described above with reference to stove 13 except that the exhaust flows from the exhaust outlet apertures 57, up the channels 66, each channel 66 functioning as an exhaust flue. The channels 66 also function as inlet ducts to allow inlet combustion air to flow down the channels 66 and into the inlet manifold via the external inlet apertures 53.

A thermally insulated tab or the like may be provided on each flap 67 to enable the flap 67 to be gripped once the stove 63 has been used, to enable the flap 67 to be pushed to the collapsed condition. This may be advantageous should the stove 63 need to be packed away relatively quickly after use, without burning the user's hands or fingers. The tab may be provided at the top margin of each flap 67.

A tab or clasp or other retainer may be provided at the top of each flap 67 to engage with the top of the respective side wall 15 to prevent the flap 67 opening inadvertently when in the collapsed condition.

It will be appreciated that any number of side walls 15, inlet apertures 53, 55 and exhaust apertures 57 may be provided as required.

Each fin 18 may be provided with a reinforcing element or elements to provide additional structural strength to each fin 18. The reinforcing element may comprise a strip of reinforcing material received within a pocket defined by the fin 18. The reinforcing material may comprise a fold of material folded around the fin 18 or over the top of the fin 18. The reinforcing material may comprise a metal material such as a tempered aluminium material for example.

It is preferred that the stove 13, 63 uses a solid fuel. An example of a solid fuel used historically is Hexamine although other fuel types are envisaged.

The stove 13, 63 may also or alternatively be used with gel fuels, ie jelly like fuels which are typically ethanol based, or liquid fuel stored in a container which can be placed on the fuel support platform 41. The stove 13, 63 may also or alternatively use gas or vaporised fuels (such as petrol, paraffin, butane or propane).

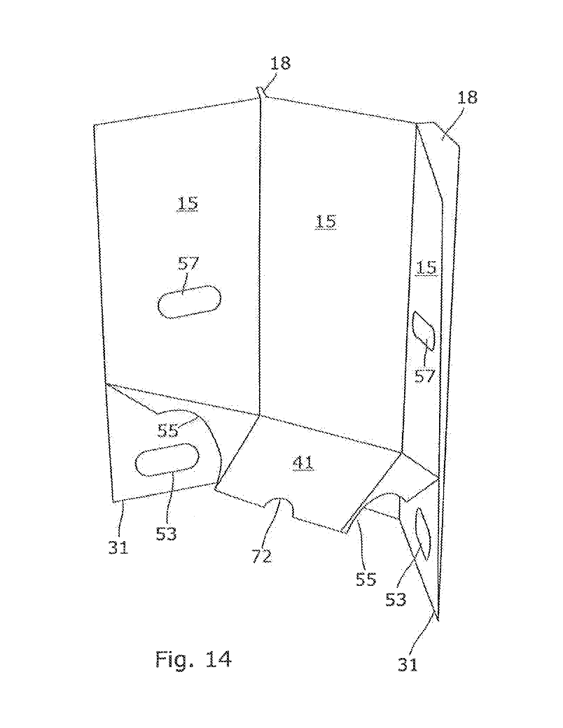

With reference to FIG. 14, a modified stove 13, 63 comprises the fuel support platform 41 as above but provided with a burner aperture 72 in which a fuel container or gas/vaporised fuel burner can be located.

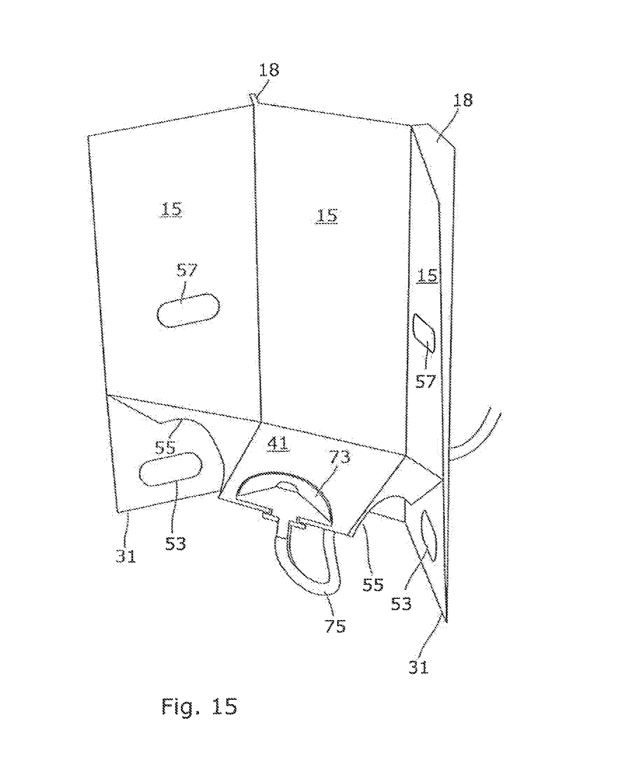

With reference to FIG. 15, a gas burner 73 is located in the burner aperture 72 with the inlet pipe 75 of the gas burner 73 passing into the inlet manifold underneath the fuel support platform 41 of the stove 13, 63, out through one of the side walls 15 of the stove 13, 63 and is connected to a suitable container (not shown) of gas/vaporised fuel.

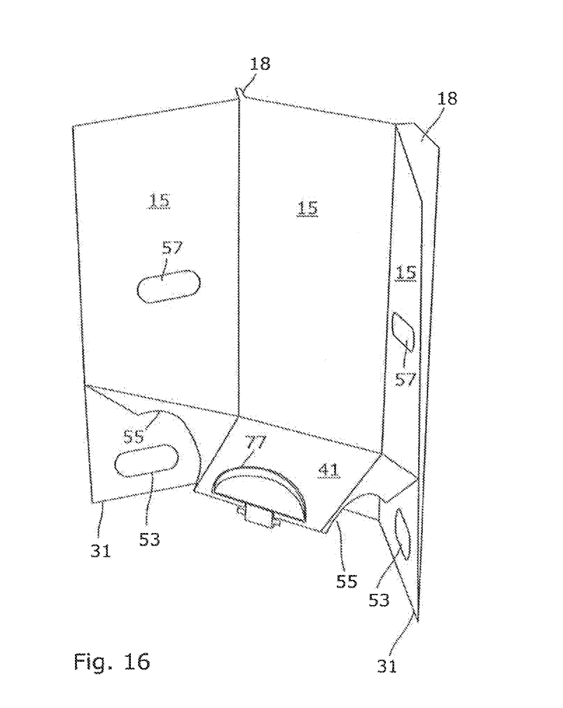

With reference to FIG. 16, a liquid fuel burner 77, such as a meth burner, is located in the burner aperture 72.

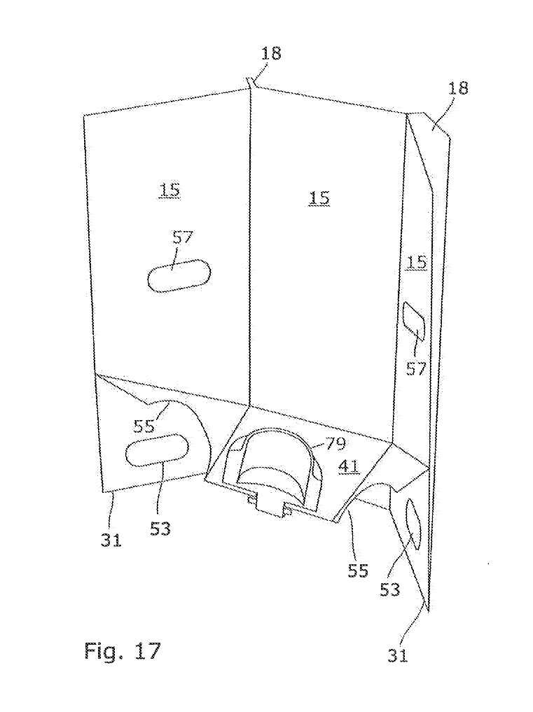

With reference to FIG. 17, a fuel container 79 is located in the burner aperture 71 and may be filled with gel type fuel for example.

1. A portable collapsible stove, the stove being formed from sheet laminate material, the laminate material comprising at least one planar non-metallic substrate and at least one planar sheet of a metal material adhered to the substrate, the stove comprising a plurality of side walls formed from the sheet laminate material, the side walls being fastened together such that the side walls together define a tube, the tube having one end which comprises a base which rests in use on the ground and a second end which comprises a mouth to at least partially receive, and support, in use a container or the like, the stove further comprising a fuel support platform also formed from the sheet laminate material, the fuel support platform being located inside the tube at a position spaced from the base of the tube, the fuel support platform having an outer periphery which is fastened to the side walls, at least one air inlet aperture being provided in one of the side walls below the fuel support platform, at least one exhaust aperture being provided in one of the side walls above the fuel support platform, the stove being collapsible from an operational condition in which the side walls define the tube and the fuel support platform extends across the tube, to a collapsed, substantially flat condition in which the side walls and fuel support platform are substantially parallel to each other, the stove further comprising at least one aperture shield arranged to extend across each of the apertures to block light emitted through the apertures in use, the at least one aperture shield comprising a vent spaced from the aperture and operative to allow gas flow through the aperture.

2. The stove of claim 1 wherein at least one of the aperture shields comprises an oblong flap fixed to one of the walls of the stove below the aperture in question, the flap having an upper part which is not fastened to the wall, and so defining a vent in communication with the aperture in question.

3. The stove of claim 2 wherein the flap is movably mounted on the wall so as to be movable from an operational condition in which the upper end of the flap is spaced from the respective wall, to a partially collapsed condition in which the upper end of the flap is adjacent the respective wall.

4. The stove of claim 3 wherein the flap has side margins which are fastened to the respective wall by way of pleated sides which allow the flap to be moveable between the operational and collapsed conditions.

5. The stove of claim 1 wherein the sheet laminate material further comprises an anti-reflecting coating.

6. The stove of claim 5 wherein the anti-reflecting coating comprises matt black paint.

7. The stove of claim 1 wherein the walls are fastened together using stitching.

8. The stove of claim 7 wherein the stitching incorporates a glass fibre thread.

9. The stove of claim 8 wherein thread is coated with at least one of PTFE and graphite.

10. The stove of claim 1 wherein the fuel support platform is fastened to the tube using stitching incorporating a fire retardant thread.

11. The stove of claim 1 further comprising a pull tab provided on the underside of the fuel support platform, whereby a user can pull the pull tab to assist with moving the stove from the collapsed condition to the operational condition.

12. The stove of claim 1 wherein each of the side walls has side margins which are bent outwardly from the wall to define a side wall fin that projects outwardly from the tube, adjacent side wall fins being fastened together.

13. The stove of claim 1 wherein the non-metallic substrate of the sheet of laminate material comprises a glass fibre mat.

14. The stove of claim 13 wherein the non metallic substrate is at least partially coated with at least one of PTFE and graphite.

15. A portable collapsible stove, the stove being formed from sheet laminate material comprising a planar non-metallic substrate having two opposite sides, and two planar sheets of a metal foil material each adhered to one of the opposite sides, the stove comprising a plurality of oblong walls formed from the sheet laminate material, the walls being joined together such that the walls together define a tube having two ends, one of the ends comprising a base which rests in use on the ground and the other of the ends comprising a mouth to at least partially receive, and support, in use a container or the like, the stove further comprising a fuel support platform also formed from the sheet laminate material, the fuel support platform being located inside the tube at a position spaced from the base of the tube, and having an outer periphery which is joined to the side walls inside the tube, at least one air inlet aperture being provided in one of the side walls below the fuel support platform, at least one exhaust aperture being provided in one of the side walls above the fuel support platform, the stove being collapsible from an operational condition in which the sidewalls define the tube and fuel support platform, to a collapsed, substantially flat condition in which the walls and fuel support platform are substantially parallel to each other.

16. A portable collapsible solid fuel stove, the stove being formed from sheet laminate material comprising a planar non-metallic substrate and at least one planar sheet of a metal foil material adhered to the substrate, the stove comprising a plurality of oblong walls formed from the sheet laminate material, each wall comprising a pair of side margins, the side margins of adjacent walls being stitched together such that the walls together define a tube having two ends, one of the ends comprising a base which rests in use on the ground and the other of the ends comprising a mouth to at least partially receive, and support, in use a container or the like, the stove further comprising a fuel support platform also formed from the sheet laminate material, the fuel support platform being located inside the tube at a position spaced from the base of the tube, the platform having an outer periphery which is stitched to the side walls inside the tube, at least one air inlet aperture being provided in one of the side walls below the fuel support platform, at least one exhaust aperture being provided in one of the side walls above the fuel support platform, the stove being collapsible from an operational condition in which the sidewalls define the tube and fuel support platform extends across the tube, to a collapsed, substantially flat condition in which the walls and fuel support platform are substantially parallel to each other.

17. A sheet of laminate material comprising at least one planar sheet of an metal foil material adhered, using fire retardant adhesive, to at least one planar non-metallic substrate, the resulting laminate sheet being fireproof such that the structural integrity of the resulting laminate sheet is stable when subject to flame temperatures of up to 1000° C., the resulting laminate sheet also being flame retardant such that the integrity of the resulting laminate sheet is stable when subject to repeated exposure to flames.

18. The stove of claim 1 wherein the laminate material is flexible.

19. The stove of claim 18 wherein the fuel support platform has two opposite sides each of which is attached to one of the side walls, and is foldable to allow the stove to be collapsed from the operation condition to the collapsed condition.
